(19) United States
(12) Patent Application Publication
(10) Pub. No.: US 2025/0326950 A1
(43) Pub. Date: Oct. 23, 2025

(54) SILSESQUIOXANE DERIVATIVE AND METHOD FOR PRODUCING SAME, CURABLE COMPOSITION, HARD COAT AGENT, CURED PRODUCT, HARD COAT, AND BASE MATERIAL

(71) Applicant: TOAGOSEI CO., LTD., Minato-ku, Tokyo (JP)

(72) Inventors: Narumi OZEKI, Nagoya-shi, Aichi (JP); Yoshiaki IWASE, Nagoya-shi, Aichi (JP)

(21) Appl. No.: 18/868,355

(22) PCT Filed: Jun. 5, 2023
(86) PCT No.: PCT/JP2023/020903

§ 371 Date: Nov. 22, 2024

(30) Foreign Application Priority Data
Jun. 10, 2022 (JP) 2022-094443

(51) Int. Cl. C09D 183/10; C08G 77/04; C08G 77/442

(52) U.S. Cl. CPC C09D 183/10; C08G 77/045; C08G 77/442

(57) ABSTRACT

The present invention provides: a silsesquioxane derivative which is represented by Formula (1), and in which a cured product obtained by curing the derivative has an elastic modulus at 23° C. of more than 4.0 GPa, and a method of producing the same; a curable composition including the silsesquioxane derivative and a polymerization initiator; a hard coat agent including the curable composition; a cured product obtained by curing the curable composition; a hard coat obtained by curing the hard coat agent; and a substrate including the hard coat. In Formula (1), at least one of u or v is a positive number.

### TECHNICAL FIELD

The present disclosure relates to a silsesquioxane derivative and a method of producing the same, a curable composition, a hard coat agent, a cured product, a hard coat, and a substrate.

### BACKGROUND ART

Hard coat agents are used in various kinds of products, such as displays and casings that is required hardness. Various curable compositions are known as compositions to be used for hard coat agents. For example, multifunctional acrylates are known.

Organic-inorganic composite compositions obtained by mixing an organic resin with an inorganic filler, and organic-inorganic hybrid materials in which organic and inorganic units coexist in nano-order or chemically bound with each other, are also drawing attention. For example, silsesquioxane derivatives are known as such organic-inorganic hybrid materials.

For example, a technique in which a curable composition is coated on a substrate using any of various known coating methods, and then the coated curable composition is cured by being irradiated with an active energy ray such as ultraviolet light, is known as a method of forming a hard coat layer. In a case in which the substrate is in the form of a film, a coating and curing method by a roll-to-roll method can be used. It is known that a nanoimprinting method can also be used for forming a hard coat layer.

For example, Japanese Patent Application Laid-Open (JP-A) No. H10-030068 discloses a coating agent composition containing an organopolysiloxane resin as a main component. This coating agent composition is obtained by hydrolyzing an organic silicon compound containing a hydrolyzable group, without using an organic solvent, and adding water in an amount of from 50 to 5,000 parts by weight with respect to 100 parts by weight of the organic silicon compound; has a number average molecular weight of 500 or more; contains from 5 to 100% by mole of silicon atoms containing a (meth)acrylic functional substituent, in the total silicon content; and contains from 30 to 100% by mole of units each represented by R¹SiX₃ (in which each X represents a group selected from the group consisting of a hydroxyl group, a hydrolyzable group and a siloxane residue; and at least one of Xs is a siloxane residue). In this coating agent composition, from 30 to 80% by mole of the units each represented by R¹SiX₃ are units each having one silanol group represented by R¹Si(OH)Y₂ (in which each Y represents a siloxane residue).

### SUMMARY OF INVENTION

### Problem to be Solved by Invention

A hard coat agent and a silsesquioxane derivative having a high hardness and a low curing shrinkage ratio are required.

JP-A No. H10-030068 discloses a technique of obtaining an article coated with a cured coating film having a high hardness and an excellent weatherability and the like, by coating a coating agent containing an organopolysiloxane resin as a main component, on a surface of a clean plastic molded product, wood-based product, ceramic, glass or metal, then irradiating a high-energy ray to polymerize and cure (meth)acrylic groups, followed by heating to carry out the condensation and curing of silanol groups. Further, JP-A No. H10-030068 discloses that the coating agent composition disclosed therein has abrasion resistance, adhesion, weatherability, flame retardancy, preservation stability and flexibility, and is capable of forming a coating film having a high hardness and flexibility, on the surface of a plastic molded product, a wood-based product, a ceramic, a glass or a metal. However, there is no description or suggestion on the curing shrinkage ratio.

The present disclosure has been made in view of the above-mentioned problem. An object of the present disclosure is to provide: a silsesquioxane derivative which has a low curing shrinkage ratio and which is capable of producing a cured product having an excellent hardness, and a method of producing the same; a curable composition containing the silsesquioxane derivative, and a cured product obtained by curing the same; as well as a hard coat agent containing the silsesquioxane derivative, a hard coat obtained by curing the same, and a substrate including the hard coat.

### Means for Solving the Problem

The means for solving the above-mentioned problem include the following embodiments.

<1> A silsesquioxane derivative represented by the following Formula (1), in which a cured product obtained by curing the derivative has an elastic modulus at 23° C. of more than 4.0 GPa:

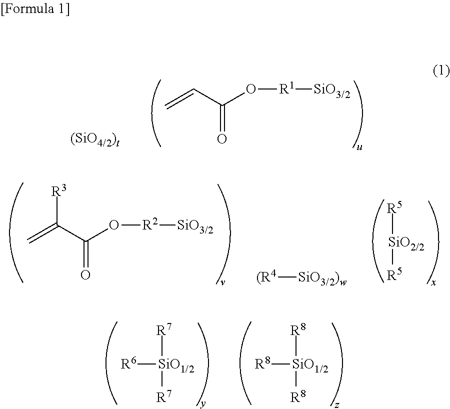

in which, in Formula (1), each of R¹ and R² independently represents an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms; R³ represents an alkyl group having from 1 to 6 carbon atoms; each of R⁴ and respective R⁵s independently represents a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms; R⁶ represents an organic group having from 2 to 12 carbon atoms and containing at least one of an ethylenically unsaturated bond or a carbon-carbon triple bond; each R⁷ and each R⁸ independently represents an alkyl group having from 1 to 10 carbon atoms, an aryl group having from 6 to 10 carbon atoms, or an aralkyl group having from 7 to 10 carbon atoms; a plurality of R⁵s may be the same as, or different from, each other; a plurality of R⁷s may be the same as, or different from, each other; a plurality of R⁸s may be the same as, or different from, one another; a part of a structure of each of R¹ to respective R⁸s may be independently substituted with a substituent or a halogen atom; each of t, u, v, w, x, y and z independently represents 0 or a positive number; and at least one of u or v is a positive number.

<2> The silsesquioxane derivative according to <1>, having a curing shrinkage ratio of 7.3% or less.

<3> The silsesquioxane derivative according to <1> or <2>, in which t, x and z are 0, and y, u, v and w satisfy 0≤y/(u+v+w)≤0.5.

<4> The silsesquioxane derivative according to <1> or <2>, in which t, y and z are 0, and x, u, v and w satisfy 0≤x/(u+v+w)≤0.5.

<5> The silsesquioxane derivative according to any one of <1> to <4>, in which each of u and v independently represents a positive number.

<6> The silsesquioxane derivative according to <5>, in which v and u satisfy 0<v/u≤1.

<7> A curable composition, including:
the silsesquioxane derivative according to any one of <1> to <6>; and
a polymerization initiator.

<8> A hard coat agent, including the curable composition according to <7>.

<9> A cured product obtained by curing the curable composition according to <7>.

<10> A hard coat obtained by curing the hard coat agent according to <8>.

<11> A substrate, including the hard coat according to <10>.

<12> A method of producing the silsesquioxane derivative according to any one of <1> to <6>, the method including a step of hydrolyzing at least one organic silicon compound represented by RₙSiXₚ using an organic solvent, and adding water in an amount of from 2 molar equivalents to 30 molar equivalents with respect to a total amount of hydrolyzable groups contained in the organic silicon compound, in which n represents an integer from 0 to 3, p represents an integer from 1 to 4, a sum of n and p is 4, R represents a group that binds to a silicon atom through a carbon atom, in the silsesquioxane derivative, and X represents a hydrolyzable group.

### Advantageous Effects of Invention

According to the present disclosure, it is possible to provide: a silsesquioxane derivative which has a low curing shrinkage ratio and which is capable of producing a cured product having an excellent hardness, and a method of producing the same; a curable composition containing the silsesquioxane derivative, and a cured product obtained by curing the same; as well as a hard coat agent containing the silsesquioxane derivative, a hard coat obtained by curing the same, and a substrate including the hard coat.

### DESCRIPTION OF EMBODIMENTS

Embodiments for carrying out the present disclosure will be described below in detail. However, the present disclosure is not limited to the following embodiments. In the embodiments described below, components (including element steps and the like) thereof are not essential, unless otherwise defined. The same applies to numerical values and ranges thereof, and the numerical values and the range thereof do not limit the present disclosure.

In the present specification, a numerical range indicated using the expression “from * to *” includes numerical values described before and after the “to” as a minimum value and a maximum value, respectively.

In numerical ranges described in stages, in the present specification, an upper limit value or a lower limit value described in one numerical range may be replaced with an upper limit value or a lower limit value in another numerical range in stages. Further, in a numerical range described in the present specification, the upper limit value or the lower limit value of the numerical range may be replaced with a value shown in Examples.

In the present specification, a combination of two or more preferred embodiments is a more preferred embodiment.

In the present specification, apart of the structure of each of R¹ to respective R⁸s in Formula (1) may be independently substituted with a substituent or a halogen atom. For example, a part of the structure of each of R¹ to respective R⁸s may be independently substituted with an alkyl group, an aryl group, an aralkyl group, a vinyl group, an epoxy group, an oxetanyl group, a hydroxyl group, an amino group, an alkylamino group, an arylamino group, an aralkylamino group, an ammonium group, a thiol group, an isocyanurate group, an ureido group, an isocyanate group, a carboxy group, an acid anhydride group, or a halogen atom.

Each of R¹ to respective R⁸s in Formula (1) may be independently non-substituted. For example, each of R¹ to R³ or R⁶ to R⁸s (preferably, each of R¹ to R³ and R⁶ to R⁸s) may be non-substituted.

### [Silsesquioxane Derivative]

A silsesquioxane derivative according to the present disclosure is represented by the following Formula (1), and a cured product obtained by curing the derivative has an elastic modulus at 23° C. of more than 4.0 GPa.

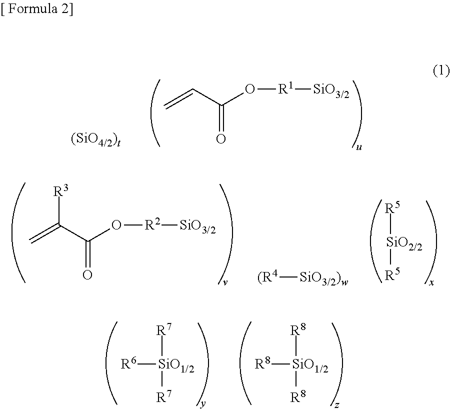

In Formula (1), each of R¹ and R² independently represents an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms; R³ represents an alkyl group having from 1 to 6 carbon atoms; each of R⁴ and respective R⁵s independently represents a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms; R⁶ represents an organic group having from 2 to 12 carbon atoms and containing at least one of an ethylenically unsaturated bond or a carbon-carbon triple bond; each R⁷ and each R⁸ independently represents an alkyl group having from 1 to 10 carbon atoms, an aryl group having from 6 to 10 carbon atoms, or an aralkyl group having from 7 to 10 carbon atoms; a plurality of R's may be the same as, or different from, each other; a plurality of R⁷s may be the same as, or different from, each other, a plurality of R⁸s may be the same as, or different from, one another; a part of the structure of each of R¹ to respective R's may be independently substituted with a substituent or a halogen atom; each of t, u, v, w, x, y and z independently represents 0 or a positive number; and at least one of u or v is a positive number.

As described above, a cured product of a conventional silsesquioxane derivative did not have a sufficient hardness and/or curing shrinkage ratio.

The present inventors have found out, as a result of intensive studies, that it is possible to provide a silsesquioxane derivative which has a low curing shrinkage ratio and which is capable of producing a cured product having an excellent hardness, by employing the above-described constitution.

It is surmised that an appropriate degree of cross-linked structure can be obtained after curing of the silsesquioxane derivative, due to at least one of u or v in Formula (1) described above being a positive number and due to hydrolysis having been performed by adding water in an amount of from 2 molar equivalents to 30 molar equivalents with respect to the total amount of hydrolyzable groups contained in the organic silicon compound, and that a silsesquioxane derivative which has a low curing shrinkage ratio and which is capable of producing a cured product having an excellent hardness can thus be obtained.

Further, the silsesquioxane derivative according to the present disclosure has an excellent storage stability and curability by an active energy ray such as ultraviolet light (hereinafter, also referred to as “UV”).

### (Elastic Modulus of Cured Product)

In the silsesquioxane derivative according to the present disclosure, a cured product obtained by curing the derivative has an elastic modulus at 23° C. of more than 4.0 GPa. From the viewpoints of the curing shrinkage ratio, the hardness, the storage stability and the ability to reduce curling during curing, the cured product preferably has an elastic modulus at 23° C. of more than 4.1 GPa, more preferably more than 4.1 GPa but equal to or less than 9.0 GPa, still more preferably from 4.15 GPa to 8.0 GPa, and particularly preferably from 4.20 GPa to 7.0 GPa.

The method of measuring the elastic modulus at 23° C. of the cured product obtained from the silsesquioxane derivative according to the present disclosure is as follows. In the present disclosure, the “silsesquioxane derivative capable of producing a cured product having an excellent hardness” means that a cured product obtained from the silsesquioxane derivative has an excellent elastic modulus.

### <Preparation of Photocurable Coating Agent>

A quantity of 0.03 parts by mass of 2-hydroxy-2-methyl-1-phenylpropan-1-one and one part by mass of propylene glycol monobutyl ether are added to one part by mass of the silsesquioxane derivative to be measured, and the resulting mixture is stirred by a rotation and revolution mixer, to prepare a photocurable coating agent.

### <Preparation of Photocured Film>

After coating the photocurable coating agent on a TAC (triacetyl cellulose) film using a No. 20 bar coater, the coated photocurable coating agent is dried at 60° C. for 10 minutes. Thereafter, the dried coating agent is cured by being irradiated with ultraviolet light under the following conditions, to obtain a photocured film. In the case of the above-described coating conditions, the resulting film has a film thickness of about 10 μm.

### —Ultraviolet Light Irradiation Conditions—

Lamp: a high-pressure mercury lamp (ECS-4011 GX, manufactured by EYE GRAPHICS Co., Ltd.)
Lamp height: 10 cm
Conveyor speed: 5.75 n/min
Cumulative amount of light per pass: 360 mJ/cm² (UV-A, a value measured by a UV POWER PUCK II, manufactured by Endicott Interconnect Technologies, Inc.)
Atmosphere: in the atmosphere
Number of passes: 10

### <Measurement of Elastic Modulus>

The indentation hardness of the resulting photocured film is measured at 23° C. and a strain rate of 0.05/s, by a nanoindenter (Nano Indenter G200 manufactured by Agilent Technologies, using a Berkovich indenter). The measured Modulus values at an indentation depth of from 500 nm to 800 nm were averaged to calculate the elastic modulus.

### (Curing Shrinkage Ratio)

The curing shrinkage ratio of the silsesquioxane derivative according to the present disclosure is preferably 7.3% or less, more preferably 7.0% or less, and particularly preferably 6.6% or less, from the viewpoints of the hardness and the ability to reduce curling during curing. Further, the lower limit value of the curing shrinkage ratio is 0%.

The method of measuring the curing shrinkage ratio of the silsesquioxane derivative according to the present disclosure is as follows.

### <Measurement of Density>

The density of the silsesquioxane derivative to be measured is measured in accordance with JIS K0061-7 (2001).

### <Preparation of Photocurable Composition>

A quantity of 0.03 parts by mass of 2-hydroxy-2-methyl-1-phenylpropan-1-one is added to one part by mass of the silsesquioxane derivative to be measured, and the resulting mixture is stirred by a rotation and revolution mixer, to prepare each photocurable composition.

### <Preparation of Photocured Product>

The prepared photocurable composition is poured into a silicone mold placed on a polyethylene terephthalate (PET) release film, another PET release film is layered on the mold, and the resultant is sandwiched with glass plates and fixed. Thereafter, the photocurable composition is cured by being irradiated with ultraviolet light under the following conditions, to obtain a photocured product.

### —Ultraviolet Light Irradiation Conditions—

Lamp: a high-pressure mercury lamp (ECS-4011 GX, manufactured by EYE GRAPHICS Co., Ltd.)
Lamp height: 10 cm
Conveyor speed: 5.75 m/min
Cumulative amount of light per pass: 360 mJ/cm² (UV-A, a value measured by a UV POWER PUCK II, manufactured by Endicott Interconnect Technologies, Inc.)
Atmosphere: in the atmosphere
Number of passes: 20

### <Measurement of Density of Photocured Product>

The density of the photocured product is measured in accordance with JS K0061-8 (2001).

### <Calculation of Curing Shrinkage Ratio>

The curing shrinkage ratio is calculated based on: (density of cured product−density before curing)/density before curing×100.

The respective structural units which can be contained in the silsesquioxane derivative according to the present disclosure are referred to as structural units (a) to (g) as shown below.

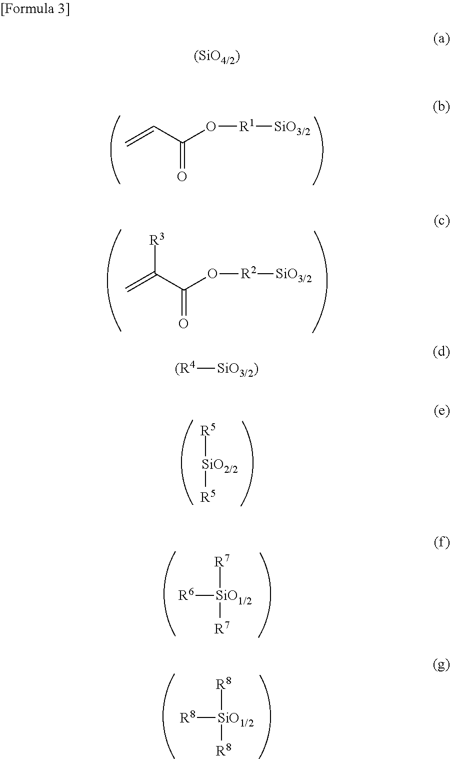

In the silsesquioxane derivative according to the present disclosure, each of t, u, y, w, x, y and z in Formula (1) independently represents 0 or a positive number, and at least one of u or v is a positive number. In other words, the silsesquioxane derivative according to the present disclosure may contain, among the structural units (a) to (g) described above, at least one of the structural unit (b) or the structural unit (c), and may contain at least one of the structural unit (a), the structural unit (d), the structural unit (e), the structural unit (f) or the structural unit (g), if necessary.

t, u, v, w, x, y and z in Formula (1) represent the molar ratios of the structural units (a) to (g), respectively. In Formula (1), t, u, v, w, x, y and z represent the relative molar ratios of the structural units (a) to (g), respectively, which can be contained in the silsesquioxane derivative represented by Formula (1). The molar ratios can be determined, for example, from the NMR (nuclear magnetic resonance) analysis values of the silsesquioxane derivative according to the present disclosure. In a case in which the reaction rates of the respective raw materials of the silsesquioxane derivative are known, or in which the yield of the derivative is 100%, the respective molar ratios can be determined from the amounts of the raw materials introduced.

For example, the molar ratio of each structural unit in the silsesquioxane derivative may be calculated by performing ¹H-NMR analysis, and further performing ²⁹Si-NMR analysis if necessary, on a sample dissolved in deuterated chloroform or the like.

It is also possible to decompose the silsesquioxane derivative into the structural units using an alkali or the like, and to deduce the structure of the original silsesquioxane derivative from the ratios of the structural units or the like.

If necessary, known methods such as mass spectrometry analysis. IR (infrared absorption spectroscopy) analysis and the like may be combined, to determine the molar ratio of each structural unit in the silsesquioxane derivative.

In Formula (1), only one kind, or two or more kinds of each of the structural units (b) to (g) may be present. Further, the order of arrangement in Formula (1) is intended to indicate the composition of the structural units, and is not intended to indicate the order of arrangement of the units in the silsesquioxane derivative. Accordingly, the form of condensation of the structural units in the silsesquioxane derivative according to the present disclosure need not necessarily be the same as the order of arrangement shown in Formula (1).

Details of the structural units (a) to (g) will be described below.

### (Structural Unit (a))

The structural unit (a) is a Q unit which contains four O_{1/2}s (two atoms in terms of oxygen atoms) with respect to one silicon atom. The “Q unit” refers to a unit having four O_{1/2}s with respect to one silicon atom.

The proportion of the structural unit (a) in the silsesquioxane derivative according to the present disclosure is not particularly limited. For example, the molar ratio (t/(t+u+v+w+x+y+z)) of the structural unit (a) in the total structural units is preferably 0.1 or less, more preferably 0.05 or less, and still more preferably 0, from the viewpoints of the viscosity of the silsesquioxane derivative and the hardness of the resulting cured product. The fact that the molar ratio is 0, in this case, means that the silsesquioxane derivative does not contain the corresponding structural unit. The same applies hereinafter.

### (Structural Unit (b))

The structural unit (b) is a T unit which contains three O_{1/2}s (1.5 atoms in terms of oxygen atoms) with respect to one silicon atom, and in which an acryloyloxy group is bound to the silicon atom through R¹. The “T unit” refers to a unit having three 012s with respect to one silicon atom.

In the structural unit (b), R¹ is an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms. R¹ is preferably an alkylene group having from 1 to 10 carbon atoms or a cycloalkylene group having from 3 to 10 carbon atoms, and more preferably an alkylene group having from 1 to 10 carbon atoms.

The alkylene group having from 1 to 10 carbon atoms is preferably an alkylene group having from 1 to 6 carbon atoms, more preferably an alkylene group having from 2 to 4 carbon atoms, and still more preferably a propylene group. The alkylene group having from 1 to 10 carbon atoms may be linear or have a branched structure.

The cycloalkylene group having from 3 to 10 carbon atoms is preferably a cycloalkylene group having from 3 to 6 carbon atoms, and more preferably a cycloalkylene group having from 4 to 6 carbon atoms. The cycloalkylene group having from 3 to 10 carbon atoms may have a branched structure.

The proportion of the structural unit (b) in the silsesquioxane derivative according to the present disclosure is not particularly limited. For example, the molar ratio (u/(t+u+v+w+x+y+z)) of the structural unit (b) in the total structural units is preferably from 0.2 to 0.99, more preferably from 0.3 to 0.9, still more preferably from 0.3 to 0.7, and particularly preferably from 0.45 to 0.65, from the viewpoints of the curing shrinkage ratio, the hardness, the storage stability, and the curability by an active energy ray such as UV.

The molar ratio of the structural unit (b) in the total structural units may be 0.

Further, from the viewpoints of the curing shrinkage ratio, the hardness, the storage stability, and the curability by an active energy ray such as UV, it is preferred that u and v satisfy u>v; it is more preferred that: molar ratio (u/(t+u+v+w+x+y+z)) of the structural unit (b)>the molar ratio (v/(t+u+v+w+x+y+z)) of the structural unit (c)+0.05 is satisfied; and it is particularly preferred that: the molar ratio (u/(t+u+v+w+x+y+z)) of the structural unit (b)> the molar ratio (v/(t+u+v+w+x+y+z)) of the structural unit (c)+0.10 is satisfied.

### (Structural Unit (c))

The structural unit (c) is a T unit which contains three O_{1/2}s (1.5 atoms in terms of oxygen atoms) with respect to one silicon atom, and in which an acryloyloxy group (such as methacryloyloxy group) whose hydrogen atom is substituted with R³ is bound to the silicon atom through R².

In the structural unit (c), R² is an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms. A preferred embodiment of R² is the same as that of R¹ in the structural unit (b).

In the structural unit (c), R³ is an alkyl group having from 1 to 6 carbon atoms. Examples of the alkyl group having from 1 to 6 carbon atoms include methyl group, ethyl group, propyl group, butyl group, pentyl group, and hexyl group. Of these, a methyl group or an ethyl group is preferred, and a methyl group is more preferred.

The proportion of the structural unit (c) in the silsesquioxane derivative according to the present disclosure is not particularly limited. For example, the molar ratio (v/(t+u+v+w+x+y+z)) of the structural unit (c) in the total structural units is preferably from 0 to 0.8, more preferably from 0.05 to 0.7, still more preferably from 0.2 to 0.7, and particularly preferably from 0.35 to 0.55, from the viewpoints of the curing shrinkage ratio, the hardness, the storage stability, and the curability by an active energy ray such as UV.

The molar ratio of the structural unit (c) in the total structural units may be 0.

In Formula (1), at least one of u or v is a positive number, and each of u and v is preferably independently a positive number, from the viewpoint of the hardness of the resulting cured product.

The total molar ratio ((u+v)/(t+u+v+w+x+y+z)) of the structural unit (b) and the structural unit (c), in the total structural units, is preferably from 0.3 to 1, more preferably from 0.5 to 1, still more preferably from 0.7 to 1, and particularly preferably from 0.9 to 1, from the viewpoints of the curing shrinkage ratio, the hardness, the storage stability, the curability by an active energy ray such as UV, and the viscosity.

### (Structural Unit (d))

The structural unit (d) is a T unit which contains three O_{1/2}s (1.5 atoms in terms of oxygen atoms) with respect to one silicon atom, and in which R⁴ is bound to the silicon atom.

In the structural unit (d), R⁴ is a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms.

The saturated or unsaturated alkyl group having from 1 to 20 carbon atoms may be linear or have a branched structure. The saturated or unsaturated alkyl group having from 1 to 20 carbon atoms is preferably a saturated or unsaturated alkyl group having from 1 to 10 carbon atoms, and more preferably a saturated alkyl group having from 1 to 10 carbon atoms.

Examples of the saturated alkyl group having from 1 to 10 carbon atoms include methyl group, ethyl group, propyl group, butyl group, pentyl group, hexyl group, heptyl group, octyl group, nonyl group, and decyl group. From the viewpoints of the heat resistance and the hardness of the resulting cured product, a methyl group or an ethyl group is preferred, and a methyl group is more preferred.

Examples of the unsaturated alkyl group having from 1 to 10 carbon atoms include vinyl group, 2-propenyl group, and ethynyl group.

The saturated or unsaturated cycloalkyl group having from 3 to 8 carbon atoms may have a branched structure. The saturated or unsaturated cycloalkyl group having from 3 to 8 carbon atoms is preferably a saturated or unsaturated cycloalkyl group having from 4 to 6 carbon atoms.

The aryl group having from 6 to 20 carbon atoms is preferably an aryl group having from 6 to 10 carbon atoms.

The aryl group having from 6 to 20 carbon atoms may be, for example, a phenyl group, a group in which one or more hydrogen atoms of a phenyl group are substituted with an alkyl group having from 1 to 10 carbon atoms, or a naphthyl group. Of these, a phenyl group is preferred from the viewpoints of the heat resistance and the hardness of the resulting cured product.

The aralkyl group having from 7 to 20 carbon atoms is preferably an aralkyl group having from 7 to 10 carbon atoms.

The aralkyl group having from 7 to 20 carbon atoms may be, for example, a group in which one of the hydrogen atoms of an alkyl group having from 1 to 10 carbon atoms is substituted with an aryl group such as a phenyl group. Such a group may be, for example, a benzyl group or a phenethyl group, and a benzyl group is preferred from the viewpoints of the heat resistance and the hardness of the resulting cured product.

In a case in which a part of the structure represented by R⁴ is substituted with a substituent or a halogen atom, examples of R⁴ include 3-glycidoxypropyl group, 2-(3,4-epoxycyclohexyl)ethyl group, 3-(3-ethyloxetan-3-yl)methoxypropyl group, 3-hydroxypropyl group, 3-aminopropyl group, 3-dimethylaminopropyl group, 3-hydroxypropyl group, a hydrochloride of 3-aminopropyl group, a hydrochloride of 3-dimethylaminopropyl group, p-styryl group, N-2-(aminoethyl)-3-aminopropyl group, N-phenyl-3-aminopropyl group, a hydrochloride of N-(vinylbenzyl)-2-aminoethyl-3-aminopropyl group, 3-ureidopropyl group, 3-mercaptopropyl group, 3-isocyanate propyl group, 3-carboxypropyl group, and 3-chloropropyl group.

The proportion of the structural unit (d) in the silsesquioxane derivative according to the present disclosure is not particularly limited. For example, the molar ratio (w/(t+u+v+w+x+y+z)) of the structural unit (d) in the total structural units is preferably 0.1 or less, more preferably 0.05 or less, and still more preferably 0, from the viewpoint of the hardness of the resulting cured product.

### (Structural Unit (e))

The structural unit (e) is a D unit which contains two O_{1/2}s (one atom in terms of oxygen atom) with respect to one silicon atom, and in which two R's are bound to the silicon atom. The “D unit” refers to a unit having two O_{1/2}s with respect to one silicon atom.

In the structural unit (e), each R⁵ is a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms. In the structural unit (d), a plurality of R⁵s may be the same as, or different from, each other. A preferred embodiment of R⁵ is the same as that of R⁴ in the structural unit (d).

The proportion of the structural unit (e) in the silsesquioxane derivative according to the present disclosure is not particularly limited. For example, the molar ratio (x/(t+u+v+w+x+y+z)) of the structural unit (e) in the total structural units is preferably 0.1 or less, more preferably 0.05 or less, still more preferably 0.025 or less, yet still more preferably 0.005 or less, and yet still more preferably 0, from the viewpoint of the hardness of the resulting cured product. From the viewpoints of the curing shrinkage ratio and the bending resistance, on the other hand, x is preferably a positive number, and the molar ratio (x/(t+u+v+w+x+y+z)) of the structural unit (e) in the total structural units is more preferably 0.005 or more, and still more preferably 0.025 or more.

### (Structural Unit (f))

The structural unit (f) is an M unit which contains one O_{1/2} (0.5 atoms in terms of oxygen atoms) with respect to one silicon atom, and in which one R⁶ and two R⁵s are bound to the silicon atom. The “M unit” refers to a unit having one O_{1/2} with respect to one silicon atom.

In the structural unit (f), R⁵ is an organic group having from 2 to 12 carbon atoms and containing at least one of an ethylenically unsaturated bond or a carbon-carbon triple bond.

Examples of the organic group having from 2 to 12 carbon atoms and containing an ethylenically unsaturated bond include vinyl group, ortho-styryl group, meta-styryl group, para-styryl group, acryloyloxymethyl group, methacryloyloxy methyl group, 2-acryloyloxyethyl group, 2-methacryloyloxyethyl group, 3-acryloyloxypropyl group, 3-methacryloyloxy propyl group, 8-acryloyloxyoctyl group, 8-methacryloyloxy octyl group, 1-propenyl group, 2-propenyl group, I-methylethenyl group, 1-butenyl group, 3-butenyl group, 1-pentenyl group, 4-pentenyl group, 3-methyl-1-butenyl group, 1-phenylethenyl group, 2-phenylethenyl group, ethynyl group, 1-propynyl group, 2-propynyl group, 1-butynyl group, 3-butynyl group, 1-pentynyl group, 4-pentynyl group, 3-methyl-1-butynyl group, and phenylbutynyl group. From the viewpoint of the hardness of the resulting cured product, a vinyl group, a 2-propenyl group, an ortho-styryl group, a meta-styryl group or a para-styryl group is preferred, and a vinyl group is more preferred.

In the structural unit (f), each R⁷ is an alkyl group having from 1 to 10 carbon atoms, an aryl group having from 6 to 10 carbon atoms, or an aralkyl group having from 7 to 10 carbon atoms. In the structural unit (f), a plurality of R⁷s may be the same as, or different from, each other.

Examples of the alkyl group having from 1 to 10 carbon atoms include methyl group, ethyl group, propyl group, butyl group, pentyl group, hexyl group, heptyl group, octyl group, nonyl group, and decyl group. From the viewpoints of the heat resistance and the hardness of the resulting cured product, a methyl group or an ethyl group is preferred, and a methyl group is more preferred.

The aryl group having from 6 to 10 carbon atoms may be, for example, a phenyl group, a group in which one or more hydrogen atoms of a phenyl group are substituted with an alkyl group having from 1 to 4 carbon atoms, or a naphthyl group. Of these, a phenyl group is preferred from the viewpoints of the heat resistance and the hardness of the resulting cured product.

The aralkyl group having from 7 to 10 carbon atoms may be, for example, a group in which one of the hydrogen atoms of an alkyl group having from 1 to 4 carbon atoms is substituted with an aryl group such as a phenyl group. Such a group may be, for example, a benzyl group or a phenethyl group, and a benzyl group is preferred from the viewpoints of the heat resistance and the hardness of the resulting cured product.

The proportion of the structural unit (f) in the silsesquioxane derivative according to the present disclosure is not particularly limited. For example, the molar ratio (y/(t+u+v+w+x+y+z)) of the structural unit (f) in the total structural units is preferably 0.5 or less, more preferably 0.3 or less, and still more preferably 0.1 or less, from the viewpoints of the curing shrinkage ratio, the hardness, the storage stability, and the curability by an active energy ray such as UV. The molar ratio (y/(t+u+v+w+x+y+z)) of the structural unit (f) in the total structural units may be 0, and may be 0.001 or more.

### (Structural Unit (g))

The structural unit (g) is an M unit which contains one O_{1/2} (0.5 atoms in terms of oxygen atoms) with respect to one silicon atom, and in which three R⁸s are bound to the silicon atom.

In the structural unit (g), each R⁸ is an alkyl group having from 1 to 10 carbon atoms, an aryl group having from 6 to 10 carbon atoms, or an aralkyl group having from 7 to 10 carbon atoms. In the structural unit (g), a plurality of R's may be the same as, or different from, one another. A preferred embodiment of R⁸ is the same as that of R⁷ in the structural unit (f).

The proportion of the structural unit (g) in the silsesquioxane derivative according to the present disclosure is not particularly limited. For example, the molar ratio (z/(t+u+v+w+x+y+z)) of the structural unit (g) in the total structural units is preferably 0.1 or less, more preferably 0.05 or less, and still more preferably 0, from the viewpoint of the hardness of the resulting cured product.

### (Other Structural Unit (h))

The silsesquioxane derivative according to the present disclosure may further contain (R⁹O_{1/2}) as a structural unit which does not contain Si (hereinafter, also referred to as “structural unit (h)”).

In (R⁹O_{1/2}), R⁹ represents a hydrogen atom or an alkyl group having from 1 to 6 carbon atoms. The alkyl group having from 1 to 6 carbon atoms may be an aliphatic group or an alicyclic group, and may be linear or branched. Specific examples of the alkyl group having from 1 to 6 carbon atoms include methyl group, ethyl group, propyl group, butyl group, pentyl group, and hexyl group.

The structural unit (h) is an alkoxy group which is a hydrolyzable group contained in a silicon compound to be described later, or an alkoxy group produced as a result of a hydrolyzable group in the silicon compound being substituted with an alcohol contained in a reaction solvent. The structural unit (h) may be one remaining in a molecule without undergoing hydrolysis or polycondensation, or may be a hydroxyl group remaining in the molecule without undergoing polycondensation after being hydrolyzed.

In Formula (1), it is preferred that t, x and z are 0, and each of w and y is independently 0 or a positive number, and it is more preferred that t, w, x, y and z are 0, from the viewpoints of the curing shrinkage ratio, the hardness, the storage stability, and the curability by an active energy ray such as UV. Further, in Formula (1), it is preferred that y, u, v and w satisfy 0≤y/(u+v+w)≤0.5, more preferably satisfy 0≤y/(u+v+w)≤0.3, and still more preferably satisfy 0≤y/(u+v+w)≤0.1 from the viewpoints of the curing shrinkage ratio, the hardness, the storage stability, and the curability by an active energy ray such as UV.

Alternatively, in Formula (1), it is preferred that t, y and z are 0, and each of w and x is independently 0 or a positive number, from the viewpoints of the curing shrinkage ratio, the hardness, the storage stability, and the curability by an active energy ray such as UV. Further, in Formula (1), it is preferred that x, u, v and w satisfy 0≤x/(u+v+w)≤0.5, more preferably satisfy 0≤x/(u+v+w)≤0.3, and still more preferably satisfy 0≤x/(u+v+w)≤0.1, from the viewpoints of the curing shrinkage ratio, the hardness, the storage stability, and the curability by an active energy ray such as UV.

In Formula (1), it is preferred that each of u and v independently represents a positive number, from the viewpoints of the curing shrinkage ratio, the hardness, the storage stability, and UV curability.

Further, it is preferred that u and v satisfy 0<v/u≤1, more preferably satisfy 0.1≤v/u≤1, still more preferably satisfy 0.2≤v/u≤1, and particularly preferably satisfy 0.3≤v/u≤1, from the viewpoints of the curing shrinkage ratio, the hardness, the storage stability, and the curability by an active energy ray such as UV.

### (Weight Average Molecular Weight of Silsesquioxane Derivative)

The silsesquioxane derivative according to the present disclosure may have a weight average molecular weight (hereinafter, also referred to as “Mw”) of, for example, from 300 to 30,000, from 500 to 15,000, from 700 to 10,000, or from 1,000 to 5,000, but not particularly limited thereto.

The “Mw” as used in the present disclosure refers to a value obtained by measuring the molecular weight by GPC (gel permeation chromatography), and converting the measured value using polystyrene as a standard material. For example, measurement conditions in the section of [Examples] to be described later can be used as the measurement conditions for the MW.

### (Viscosity of Silsesquioxane Derivative)

The silsesquioxane derivative according to the present disclosure preferably has a viscosity at 25° C. of from 10 mPa·s to 50,000 mPa·s, more preferably from 100 mPa·s to 40,000 mPa·s, still more preferably from 1,000 mPa·s to 30,000 mPa·s, and particularly preferably from 2,000 mPa·s to 20,000 mPa·s.

In the present disclosure, the “viscosity at 25° C.” refers to a value measured using a Type E viscosimeter (a cone-plate viscometer, such as a Model TVE22H viscometer, manufactured by Toki Sangyo Co., Ltd.).

### (Method of Producing Silsesquioxane Derivative)

The silsesquioxane derivative according to the present disclosure can be produced by a known method. The method of producing the silsesquioxane derivative is described in detail as the method of producing a polysiloxane, in WO 2013/031798 and the like.

In particular, the method of producing the silsesquioxane derivative according to the present disclosure preferably includes the step (hereinafter, referred to as “hydrolysis step”) of hydrolyzing at least one organic silicon compound represented by RₙSiXₚ using an organic solvent, and adding water in an amount of from 2 molar equivalents to 30 molar equivalents with respect to the total amount of hydrolyzable groups contained in the organic silicon compound, in which n represents an integer from 0 to 3, p represents an integer from 1 to 4, the sum of n and p is 4, R represents a group that binds to a silicon atom through a carbon atom, in the silsesquioxane derivative, and X represents a hydrolyzable group.

In RₙSiXₚ, R may preferably be, for example, a group (H₂C═CHCOO—R¹—. H₂C═C(R³)COO—R²—, any of R⁴ to R⁸, or the like) that binds to a silicon atom in the silsesquioxane derivative through a carbon atom.

X may preferably be, for example, an alkoxy group, a silyloxy group or a halogen atom, and more preferably an alkoxy group or a silyloxy group.

In the hydrolysis step, it is preferred to perform the hydrolysis and polycondensation reactions of the organic silicon compound, and if necessary, of another silicon compound, rather than just performing the hydrolysis of the organic silicon compound.

Further, in the hydrolysis step, after performing the hydrolysis and polycondensation reactions of the organic silicon compound, and if necessary, of another silicon compound, to obtain a silsesquioxane derivative as an intermediate product, the hydrolysis and polycondensation reactions of the resulting intermediate product and the organic silicon compound and the like may further be performed.

In the case of obtaining an intermediate product as described above, it is also possible, after performing the hydrolysis and polycondensation reactions of the organic silicon compound, and if necessary, of another silicon compound, to further perform the hydrolysis and polycondensation reactions of the resulting intermediate product and the organic silicon compound in which n is 3 and p is 1. This makes it possible to suitably synthesize a silsesquioxane derivative whose end is capped with the structural unit (f) derived from the organic silicon compound in which n is 3 and p is 1, to reduce an increase in the viscosity of the silsesquioxane derivative, and to achieve a better storage stability.

The method of producing the silsesquioxane derivative according to the present disclosure preferably includes, after performing the hydrolysis and polycondensation reactions of the silicon compound in the presence of a reaction solvent, a distillation step of removing the reaction solvent, by-products, residual monomers, water and the like, in the resulting reaction liquid.

Examples of the organic silicon compound containing an acryloyl group, among the organic silicon compounds, include (3-acryloyloxypropyl)trimethoxysilane, (3-acryloyloxypropyl)triethoxysilane, (8-acryloyloxyoctyl)trimethoxysilane, and (3-acryloyloxypropyl)trichlorosilane.

Examples of the organic silicon compound containing a methacryloyl group, among the organic silicon compounds, include (3-methacryloyloxypropyl)trimethoxysilane, (3-methacryloyloxvpropyl)triethoxysilane, (8-methacryloyloxyoctyl)trimethoxysilane, and (3-methacryloyloxypropyl)trichlorosilane.

Examples of the organic silicon compound that gives two structural units (f) by hydrolysis include: 1,3-divinyltetramethyldisiloxane, 1,3-bis(p-styryl)tetramethyldisiloxane, 1,3-bis(3-acryloyloxypropyl)tetramethyldisiloxane and 1,3-bis(3-methacryloyloxy propyl)tetramethyldisiloxane; as well as methoxydimethylvinylsilane, ethoxydimethylvinylsilane, chlorodimethylvinylsilane, dimethylvinylsilanol, (3-acryloyloxypropyl)dimethylmethoxysilane, (3-methacryloyloxypropyl)dimethylmethoxysilane, p-styryldimethylmethoxysilane, and ethynyldimethylmethoxysilane.

Examples of the silicon compound that gives the structural unit (a) by hydrolysis include tetramethoxysilane, and tetraethoxysilane.

Examples of the organic silicon compound in which n is 3 and p is 1 include methyltrimethoxysilane, methyltriethoxysilane, ethyltrimethoxysilane, propyltrimethoxysilane, octyltrimethoxysilane, phenyltrimethoxysilane, phenyltriethoxysilane, benzyltrimethoxysilane, cyclohexyltrimethoxvsilane, vinyltrimethoxysilane, allyltrimethoxysilane, p-styryltimethoxysilane, ethynyltrimethoxysilane, 2-(3,4-epoxycyclohexyl)ethyltrimethoxysilane, 3-glycidoxypropyltrimethoxysilane, N-2-(aminoethyl)-3-aminopropyltrimethoxysilane, 3-aminopropyltrimethoxysilane, 3-triethoxysilyl-N-(1,3-dimethyl-butylidene)propylamine, N-phenyl-3-aminopropyltrimethoxysilane, a hydrochloride of N-(vinylbenzyl)-2-aminoethyl-3-aminopropyltrimethoxysilane, 3-ureidopropyltrimethoxysilane, 3-ureidopropyltriethoxysilane, 3-isocyanatopropyltriethoxysilane, tris(trimethoxysilylpropyl)isocyanurate, 3-mercaptopropyltrimethoxysilane, 3-ethyl-3-[{3-(trimethoxysilyl)propoxy}methyl]oxetane, and 3-ethyl-3-[{3-(triethoxysilyl)propoxy}methyl]oxetane.

Examples of the organic silicon compound in which n is 2 and p is 2 include dimethyldimethoxysilane, dimethyldiethoxysilane, diethyldiethoxysilane, propylmethyldimethoxysilane, octyl methyldimethoxysilane, phenylmethyldimethoxysilane, diphenyldiethoxysilane, benzylmethyldimethoxysilane, cyclohexylmethyldimethoxysilane, vinvlmethyldimethoxysilane, allylmethyldimethoxysilane, p-styrylmethyldimethoxysilane, ethynylmethyldimethoxysilane, 2-(3,4-epoxycyclohexyl)ethylmethyldimethoxvsilane, 3-glycidoxypropylmethyldimethoxysilane, N-2-(aminoethyl)-3-aminopropylmethyldimethoxysilane, 3-aminopropylmethyldimethoxysilane, N-phenyl-3-aminopropylmethyldimethoxysilane, a hydrochloride of N-(vinylbenzyl)-2-aminoethyl-3-aminopropylmethyldimethoxysilane, 3-ureidopropylmethyldialkoxysilane, 3-isocyanatepropylmethyldiethoxysilane. (3-acryloxypropyl)methyldimethoxysilane, and (3-methacryloxypropyl)methyldiethoxysilane.

Examples of the organic silicon compound in which n is 1 and p is 3 include hexamethyldisiloxane, trimethyimethoxysilane, trimethylethoxysilane, trimethylchlorosilane, and dimethylphenylmethoxysilane.

The reaction solvent to be used in the hydrolysis step is not particularly limited, but it is preferred to use an alcohol as the organic solvent. The alcohol as used herein is an alcohol in a strict sense, which is represented by Formula R—OH, and is a compound that does not contain a functional group other than an alcoholic hydroxyl group.

The alcohol is not particularly limited, and examples thereof include methanol, ethanol, 1-propanol, 2-propanol, 2-butanol, 2-pentanol, 3-pentanol, 2-methyl-2-butanol, 3-methyl-2-butanol, cyclopentanol, 2-hexanol, 3-hexanol, 2-methyl-2-pentanol, 3-methyl-2-pentanol, 2-methyl-3-pentanol, 3-methyl-3-pentanol, 2-ethyl-2-butanol, 2,3-dimethyl-2-butanol, and cyclohexanol. Of these, a secondary alcohol such as 2-propanol, 2-butanol, 2-pentanol, 3-pentanol, 3-methyl-2-butanol, cyclopentanol, 2-hexanol, 3-hexanol, 3-methyl-2-pentanol or cyclohexanol is preferred.

In the hydrolysis step, these alcohols may be used singly, or in combination of two or more kinds thereof.

The organic solvent to be used in the hydrolysis step may be only alcohol, or may further be a mixed solvent with at least one kind of co-solvent. The co-solvent may be a polar solvent or a non-polar solvent, or may be a combination of both kinds of solvents.

Examples of the organic solvent other than the alcohol include xylene, toluene, methyl ethyl ketone, methyl isobutyl ketone, and propylene glycol monomethyl ether.

The hydrolysis and condensation reactions in the hydrolysis step proceed in the presence of water.

In the hydrolysis step, it is preferred to perform hydrolysis by adding water in an amount of from 1.5 molar equivalents to 30 molar equivalents with respect to the total amount of hydrolyzable groups contained in the organic silicon compound, and to further perform condensation.

The amount of water to be added in the hydrolysis step is preferably from 1.7 molar equivalents to 8 molar equivalents, more preferably from 1.9 molar equivalents to 7 molar equivalents, still more preferably from 2.0 molar equivalents to 7 molar equivalents, particularly preferably from 2.2 molar equivalents to 7 molar equivalents, and most preferably from 2.4 molar equivalents to 6 molar equivalents, with respect to the total amount of hydrolyzable groups contained in the organic silicon compound, from the viewpoints of the curing shrinkage ratio, the hardness, the storage stability and the ability to reduce curling during curing, of the resulting silsesquioxane derivative.

Further, the hydrolysis and polycondensation reactions of the silicon compound can be performed with or without using a catalyst. In the case of using a catalyst, an acid catalyst exemplified by an inorganic acid such as sulfuric acid, nitric acid, hydrochloric acid or phosphoric acid, or an organic acid such as formic acid, acetic acid, oxalic acid or paratoluenesulfonic acid, or a base catalyst such as ammonia, tetramethylammonium hydroxide, sodium hydroxide, potassium hydroxide, sodium carbonate or potassium carbonate, is preferably used, and an acid catalyst is more preferably used.

The catalyst is used preferably in an amount corresponding to from 0.1% by mole to 20% by mole, and more preferably in an amount corresponding to from 0.01% by mole to 10% by mole, with respect to the total amount (moles) of silicon atoms contained in the silicon compound.

The completion of the hydrolysis and poly condensation reactions in the hydrolysis step can be detected as appropriate, by a method described in any of various publications and the like. In the hydrolysis step of the method of producing the silsesquioxane derivative according to the present disclosure, it is possible to add an aid to a reaction system.

By including the above-described distillation step, after the completion of the hydrolysis step in the production of the silsesquioxane derivative according to the present disclosure, it is possible to improve the stability of the produced silsesquioxane derivative according to the present disclosure. The distillation can be performed at normal pressure or under reduced pressure, and can be performed at normal temperature or under heating, or also under cooling.

The method of producing the silsesquioxane derivative can include a neutralization step of neutralizing the catalyst, before the distillation step. Further, the method can also include the step of removing a salt formed by neutralization, by water washing or the like.

The silsesquioxane derivative represented by Formula (1) may contain a group formed by the addition of an acid or the like to an oxetanyl group or an epoxy group, among side-chain functional groups derived from the silicon compound used as a raw material in the production of the derivative, to undergo ring opening. Alternatively, the silsesquioxane derivative may contain a hydroxyalkyl group formed by the decomposition of an organic group containing a (meth)acryloyl group, or a group formed by the addition of an acid or the like to an unsaturated hydrocarbon group or the like. Specific examples thereof include one in which a structure represented by the following Formula (A) and/or a structure represented by the following Formula (B) is/are included as a part of Formula (1). In a case in which the content ratio thereof is 50% by mole or less, with respect to the amount corresponding to that of the original organic group containing an oxetanyl group or an epoxy group, the original organic group containing a (meth)acryloyl group, or the original organic group containing an unsaturated hydrocarbon group, derived from the silicon compound as a raw material, the present disclosure can be carried out without any problems. The content ratio is preferably 30% by mole or less, and more preferably 10% by mole or less. In each of Formula (A) and Formula (B), a T unit is shown as an example. However, the structure represented by each Formula may be a similar D unit, a M unit or the like.

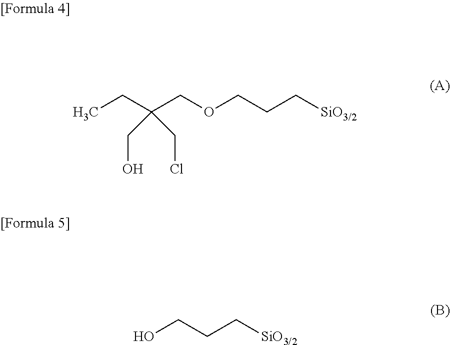

### [Curable Composition]

A curable composition according to the present disclosure contains the silsesquioxane derivative according to the present disclosure, and a polymerization initiator. The curable composition according to the present disclosure can be suitably used as a hard coat agent.

The curable composition according to the present disclosure may contain any of various components (hereinafter, also referred to as “other components”), if necessary.

### (Polymerization Initiator)

The polymerization initiator is not particularly limited, and may be, for example, a photopolymerization initiator or a thermal polymerization initiator The photopolymerization initiator may be, for example, a photoradical polymerization initiator.

The thermal polymerization initiator may be, for example, a thermal radical polymerization initiator.

A known compound may be used as the photopolymerization initiator or the thermal polymerization initiator.

Examples of the photoradical polymerization initiator include: acetophenone-based compounds such as 2,2-dimethoxy-1,2-diphenylethan-1-one, 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, 2-methyl-1-[4-(methylthio)phenyl]-2-morpholinopropan-1-one, 2-benzyl-2-dimethylamino-1-(4-morpholinophenyl)-butan-1-one, diethoxyacetophenone, oligo[2-hydroxy-2-methyl-1-[4-(1-methylvinyl)phenyl]propanone], and 2-hydroxy-1-{4-[4-(2-hydroxy-2-methyl-propionyl)benzyl]phenyl}-2-methyl-propan-1-one; benzophenone-based compounds such as benzophenone, 4-phenylbenzophenone, 2,4,6-trimethylbenzophenone, and 4-benzoyl-4′-methyldiphenylsulfide; α-ketoester-based compounds such as methylbenzovl formate, oxyphenylacetic acid 2-[2-oxo-2-phenylacetoxy ethoxy]ethyl ester, and oxyphenylacetic acid 2-[2-hydroxyethoxy]ethyl ester; phosphine oxide-based compounds such as 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide; benzoin-based compounds such as benzoin, benzoin methyl ether, benzoin ethyl ether, benzoin isopropyl ether, and benzoin isobutyl ether; titanocene-based compounds; acetophenone/benzophenone hybrid-based photoinitiators such as 1-(4-(4-benzoylphenylsulfanyl)phenyl)-2-methyl-2-(4-methylphenyl sulfinyl)propan-1-one; oxime ester-based photopolymerization initiators such as 1-(4-phenylthio phenyl)-2-(O-benzoyloxime)-1,2-octanedione; and camphorquinone. These photoradical polymerization initiators may be used singly, or two or more kinds thereof can be used in combination.

The thermal radical polymerization initiator is not particularly limited, and may be, for example, a peroxide or an azo initiator.

Examples of the peroxide include: hydrogen peroxide; inorganic peroxides such as sodium persulfate, ammonium persulfate and potassium persulfate; and organic peroxides such as 1,1-bis(t-butylperoxy)2-methylcyclohexane, 1,1-bis(t-hexylperoxy)-3,3,5-trimethylcyclohexane, 1,1-bis(t-hexylperoxy)cyclohexane, 1,1-bis(t-butvlperoxy)-3,3,5-trimethylcyclohexane, 1,1-bis(t-butylperoxy)cyclohexane, 2,2-bis(4,4-di-butylperoxycyclohexyl)propane, 1,1-bis(t-butylperoxy)cyclododecane, t-hexylperoxyisopropyl monocarbonate, t-butylperoxymaleic acid, t-butylperoxy-3,5,5-trimethylhexanoate, t-butyl peroxylaurate, 2,5-dimethyl-2,5-di(m-toluoylperoxy)hexane, t-butylperoxvisopropyl monocarbonate, t-butylperoxy-2-ethylhexyl monocarbonate, t-hexyl peroxybenzoate, 2,5-dimethyl-2,5-di(benzoylperoxy)hexane, t-butyl peroxy acetate, 2,2-bis(t-butylperoxy)butane, t-butyl peroxybenzoate, n-butyl-4,4-bis(t-butylperoxy) valerate, di-t-butyl peroxvisophthalate, α,α′-bis(t-butylperoxy)diisopropylbenzene, dicumyl peroxide, 2,5-dimethyl-2,5-di(t-butylperoxy)hexane, t-butyl cumyl peroxide, di-t-butyl peroxide, p-menthane hydroperoxide, 2,5-dimethyl-2,5-di(t-butylperoxy)hexyne-3, diisopropylbenzene hydroperoxide, t-butyl trimethylsilyl peroxide, 1,1,3,3-tetramethylbutyl hydroperoxide, cumene hydroperoxide, t-hexyl hydroperoxide and t-butyl hydroperoxide.

These peroxides may be used singly, or two or more kinds thereof can be used in combination.

Examples of the azo initiator include azo compounds such as 2,2-azobisisobutyro nitrile, 1,1′-azobis(cyclohexane-1-carbonitrile), 2-(carbamoylazo)isobutyronitrile, 2-phenylazo-4-methoxy-2,4-dimethylvaleronitrile, azo di-t-octane, and azo di-t-butane. These azo initiators may be used singly, or two or more kinds thereof can be used in combination.

It is also possible to perform a Redox reaction, by combining with a Redox polymerization initiator system, in which a peroxide, and a reducing agent such as ascorbic acid, sodium ascorbate, sodium erythorbate, tartaric acid, citric acid, a metal salt of formaldehyde sulfoxylate, sodium thiosulfate, sodium sulfite, sodium bisulfite, sodium metabisulfite or ferric chloride, are used in combination.

The content of the polymerization initiator in the curable composition according to the present disclosure is preferably from 0.01 parts by mass to 20 parts by mass, more preferably from 0.1 parts by mass to 10 parts by mass, and still more preferably from one part by mass to 5 parts by mass, with respect to 100 parts by mass of the silsesquioxane derivative represented by Formula (0).

### (Other Components)

The other components are not particularly limited. Examples of the other components include a solvent, a polymerizable compound other than the silsesquioxane derivative represented by Formula (1), a resin, a silicone, a monomer, a filler, a surfactant, an antistatic agent (such as an electrically conductive polymer), a leveling agent, a photosensitizer, an ultraviolet absorber, an antioxidant, a heat resistance improver, a stabilizer, a lubricant, a pigment, a dye, a plasticizer, a suspending agent, an adhesion-imparting agent, nanoparticles, nanofibers, and a nanosheet. The curable composition according to the present disclosure may contain a silane-based reactive diluent, such as a tetraalkoxysilane, a trialkoxysilane, a dialkoxysilane, a monoalkoxysilane, or a disiloxane.

The curable composition according to the present disclosure may but need not contain a solvent.

Examples of the solvent include various kinds of organic solvents, such as aliphatic hydrocarbon solvents, aromatic hydrocarbon solvents, chlorinated hydrocarbon solvents, alcohol solvent, ether solvents, amide solvents, ketone solvents, ester solvents, and cellosolve solvents.

The curable composition according to the present disclosure may but need not a polymerizable compound (hereinafter, also referred to as an “other polymerizable compound”) other than the silsesquioxane derivative represented by Formula (1).

The other polymerizable compound is not particularly limited, as long as the compound is capable of undergoing a polymerization reaction in the presence of the silsesquioxane derivative represented by Formula (1) and a polymerization initiator. The other polymerizable compound may be, for example, a silsesquioxane derivative other than the silsesquioxane derivative represented by Formula (1), a (meth)acrylate compound, a compound containing an ethylenically unsaturated group, an epoxy compound (compound containing an epoxy group), a compound containing an oxetanyl group (oxetanyl group-containing compound), or a compound containing a vinyl ether group (vinyl ether compound).

Examples of the silsesquioxane derivative other than the silsesquioxane derivative represented by Formula (1) include a silsesquioxane derivative consisting of T units, and a silsesquioxane derivative containing a T unit and a D unit.

The (meth)acrylate compound is not particularly limited, and may be, for example, a compound (hereinafter, also referred to as “monofunctional (meth)acrylate”) having one (meth)acryloyl group, or a compound (hereinafter, also referred to as “multifunctional (meth)acrylate”) having two or more (meth)acryloyl groups.

Examples of the monofunctional (meth)acrylate include:
alkyl (meth)acrylates such as methyl (meth)acrylate, ethyl (meth)acrylate, butyl (meth)acrylate, and 2-ethylhexyl (meth)acrylate;
monofunctional (meth)acrylates containing an alicyclic group, such as cyclohexyl (meth)acrylate, tert-butylcyclohexyl (meth)acrylate, isobornyl (meth)acrylate, and tricyclodecanemethylol (meth)acrylate,
monofunctional (meth)acrylates containing an aromatic group, such as benzyl(meth)acrylate, and phenyl(meth)acrylate;
(meth)acrylates of alkylene oxide adducts of phenol derivatives, such as (meth)acrylates of phenol ethylene oxide adducts, (meth)acrylates of phenol propylene oxide adducts, (meth)acrylates of modified nonylphenol ethylene oxide adducts, (meth)acrylates of nonylphenol propylene oxide adducts, (meth)acrylates of alkylene oxide adducts of para-cumylphenol, orthophenylphenol (meth)acrylate, and (meth)acrylates of alkylene oxide adducts of orthophenylphenol;
monofunctional (meth)acrylates containing an alkoxyalkyl group, such as 2-ethylhexylcarbitol(meth)acrylate;
monofunctional (meth)acrylates containing a heterocyclic ring, such as tetrahydrofurfuryl (meth)acrylate, and N-(2-(meth)acryloxyethyl)hexahydrophthalimide;
hydroxylalkyl (meth)acrylates such as hydroxyethyl (meth)acrylate, hydroxypropyl (meth)acrylate, hydroxybutyl (meth)acrylate, and hydroxyhexyl (meth)acrylate;
monofunctional (meth)acrylates containing a hydroxyl group and an aromatic group, such as 2-hydroxy-3-phenoxypropyl (meth)acrylate;
alkylene glycol mono(meth)acrylates such as diethylene glycol mono(meth)acrylate, dipropylene glycol mono(meth)acrylate, triethylene glycol mono(meth)acrylate, and tripropylene glycol mono(meth)acrylate; and
monofunctional (meth)acrylates containing a carboxy group, such as ω-carboxypolycaprolactone mono(meth)acrylate, and phthalic acid monohydroxyethyl(meta)acrylate.

Examples of the multifunctional (meth)acrylate include:
polyethylene glycol di(meth)acrylates such as diethylene glycol di(meth)acrylate, triethylene glycol di(meth)acrylate, and tetraethylene glycol di(meth)acrylate;
polypropylene glycol di(meth)acrylates such as dipropylene glycol di(meth)acrylate, tripropylene glycol di(meth)acrylate, and tetrapropylene glycol di(meth)acrylate; and
1,4-butanediol di(meth)acrylate, neopentyl glycol di(meth)acrylate, di(meth)acrylate of ethylene oxide-modified neopentyl glycol, di(meth)acrylate of ethylene oxide-modified bisphenol A, di(meth)acrylate of propylene oxide-modified bisphenol A, di(meth)acrylate of ethylene oxide-modified hydrogenated bisphenol A, trimethylolpropane di(meth)acrylate, trimethylolpropane allyl ether di(meth)acrylate, trimethylolpropane tri(meth)acrylate, ethylene oxide-modified trimethylolpropane tri(meth)acrylate, propylene oxide-modified trimethylolpropane tri(meth)acrylate, pentaerythritol tri(meth)acrylate, pentaerythritol tetra(meth)acrylate, and dipentaerythritol hexaacrylate.

It is also possible to use a urethane (meth)acrylate as the multifunctional (meth)acrylate.

The urethane (meth)acrylate may be, for example, a compound obtained by the addition reaction of an organic polyisocyanate and a hydroxyl group-containing (meth)acrylate, or a compound obtained by the addition reaction of an organic polyisocyanate, a polyol, and a hydroxyl group-containing (meth)acrylate.

The monofunctional (meth)acrylates, the multifunctional (meth)acrylates and the like may be used singly, two or more of kind can be used in combination, or different kinds thereof can be used in combination.

The polyol as used herein may be, for example, a low molecular weight polyol, a polyether polyol, a polyester polyol, or a polycarbonate polyol.

Examples of the low molecular weight polyol include ethylene glycol, propylene glycol, neopentyl glycol, cyclohexane dimethylol, and 3-methyl-1,5-pentanediol.

Examples of the polyether polyol include polypropylene glycol, and polytetramethylene glycol.

Examples of the polyester polyol include a reaction product of such a low molecular weight polyol and/or polyether polyol, with a dibasic acid such as adipic acid, succinic acid, phthalic acid, hexahydrophthalic acid or terephthalic acid, or with an acid component such as an anhydride thereof.

These compounds may be used singly, two or more of kind can be used in combination, or different kinds thereof can be used in combination.

Examples of the organic polyisocyanate include tolylene diisocyanate, xylylene diisocyanate, tetramethylxylylene diisocyanate, 4,4′-diphenylmethane diisocyanate, 4,4′-dicyclohexylmethane diisocyanate, hexamethylene diisocyanate, and isophorone diisocyanate.

Examples of the hydroxyl group-containing (meth)acrylate include: hydroxyalkyl (meth)acrylates such as 2-hydroxyethyl (meth)acrylate, 2-hydroxypropyl (meth)acrylate, and 4-hydroxybutyl (meth)acrylate; and hydroxyl group-containing multifunctional (meth)acrylates such as pentaerythritol tri(meth)acrylate, di(meth)acrylates of alkylene oxide 3-mole adducts of isocyanuric acid, and dipentaerythritol penta(meth)acrylate.

These compounds may be used singly, two or more of kind can be used in combination, or different kinds thereof can be used in combination.

In a case in which the (meth)acrylate compound is used in combination in the curable composition according to the present disclosure, the mixing proportion thereof is not particularly limited. For example, the mixing proportion of the (meth)acrylate compound is preferably from 0 parts by mass to 100 parts by mass, more preferably from 0 parts by mass to 50 parts by mass, and still more preferably from 0 parts by mass to 20 parts by mass, with respect to 100 parts by mass of the silsesquioxane derivative represented by Formula (1) described above. From the viewpoint of the adhesion with an inorganic substance layer, the mixing proportion of the (meth)acrylate compound is the lower the more preferred. It is preferred that the curable composition does not contain the (meth)acrylate compound, or contains the compound in a content of 10% by mass or less with respect to the total amount of the composition; it is more preferred that the curable composition does not contain the (meth)acrylate compound, or contains the compound in a content of 5% by mass or less with respect to the total amount of the composition; it is still more preferred that the curable composition does not contain the (meth)acrylate compound, or contains the compound in a content of 1% by mass or less with respect to the total amount of the composition; and it is particularly preferred that the curable composition does not contain the (meth)acrylate compound.

A compound having one ethylenically unsaturated group within one molecule, other than the (meth)acrylate compound described above, may be added to the curable composition.

The ethylenically unsaturated group is preferably a (meth)acryloyl group, a maleimide group, a (meth)acrylamide group, or a vinyl group.

Specific examples of the compound having an ethylenically unsaturated group include (meth)acrylic acid, a Michael addition type dimer of acrylic acid, N-(2-hydroxyethyl)citraconimide, N,N-dimethylacrylamide, acryloylmorpholine, N-vinylpyrrolidone, and N-vinylcaprolactam.

These compounds may be used singly, or two or more kinds thereof can be used in combination.

Examples of the epoxy compound include monofunctional epoxy compounds and multifunctional epoxy compounds.

Examples of the oxetanyl group-containing compound include monofunctional oxetane compounds and multifunctional oxetane compounds.

Examples of the vinyl ether compound include monofunctional vinyl ether compounds and multifunctional vinyl ether compounds.

For example, any of the compounds described in JP-A No. 201142755 may be used as such a compound.

The silicone is not particularly limited, and a known silicone can be used. Examples of the silicone include polydimethyl silicone, polydiphenyl silicone and polymethylphenyl silicone, and a silicone having a functional group at an end and/or a side chain thereof is preferred. The functional group is not particularly limited, and examples thereof include (meth)acryloyl group, epoxy group, oxetanyl group, vinyl group, hydroxyl group, carboxy group, amino group, and thiol group.

In a case in which the curable composition according to the present disclosure contains the other polymerizable compound, the content of the other polymerizable compound is preferably from 0.01 parts by mass to 100 parts by mass, more preferably from 0.1 parts by mass to 50 parts by mass, and still more preferably from one part by mass to 25 parts by mass, with respect to 100 parts by mass of the silsesquioxane derivative represented by Formula (1).

### [Cured Product]

A cured product according to the present disclosure is obtained by curing the curable composition according to the present disclosure. For example, the cured product according to the present disclosure can be obtained by irradiating an active energy ray to the curable composition according to the present disclosure, or by heating the curable composition according to the present disclosure.

In the case of curing the curable composition according to the present disclosure, the curing may be performed after coating the curable composition on a substrate.

The curable composition according to the present disclosure may but need not contain a solvent. In a case in which the curable composition contains a solvent, it is preferred to cure the composition after removing the solvent.

In the case of coating the curable composition according to the present disclosure on a substrate, the method of coating the curable composition is not particularly limited. Examples of the coating method include ordinary coating methods such as cast coating, spin coating, bar coating, dip coating, spray coating, roll coating, flow coating, and gravure coating.

The thickness of the curable composition according to the present disclosure to be coated is not particularly limited, and can be set as appropriate, depending on a purpose.

The substrate on which the curable composition according to the present disclosure is to be coated is not particularly limited, and the substrate may be, for example, a wood, a metal, an inorganic material, a plastic, a paper, fibers, or a fabric.

Examples of the metal include copper, silver, iron, aluminum, silicon, silicon steel, and stainless steel. Examples of the inorganic material include: metal oxides such as aluminum oxide, silicon oxide, magnesium oxide, zirconium oxide, zinc oxide, indium tin oxide, and gallium oxide; metal nitrides such as aluminum nitride, gallium nitride, and silicon nitride; ceramics such as silicon carbide and boron nitride; mortar; concrete; and glass. Specific examples of the plastic include: acrylic resins such polymethyl methacrylate; polyester resins such as polyethylene terephthalate; polyamide resins such as polyvinyl chloride resins, polycarbonate resins, epoxy resins, Nylon, and aramid; fluorine resins such as polyimide resins, polyamideimide resins, and tetrafluoroethylene resins; polyolefin resins such as crosslinked polyethylene resins; acetyl cellulose resins such as vinylidene chloride resins, acrylonitrile-butadiene-styrene (ABS) resins, polystyrene resins, polyacrylonitrile resins, cycloolefin polymers (COP), cycloolefin copolymers (COC), acetate-based resins, polyarylates, cellophanes, norbomene-based resins, and triacetyl cellulose (TAC); composite resins such as polychloroprene, polyphenylene sulfide, polysulfone, polyether sulfone, polyether ether ketone, polyurethane resins, and glass epoxy resins; and various kinds of fiber-reinforced resins.

Examples of the fibers include natural fibers, regenerated fibers, semi-synthetic fibers, metal fibers, glass fibers, carbon fibers, ceramic fibers, and known chemical fibers. The fabric may be a woven fabric or a nonwoven fabric, and can be produced using, for example, any of the fibers described above.

These materials may be used singly, or alternatively, two or more kinds thereof may be used in combination, or used as a mixture or a complex.

The form of the substrate is not particularly limited, and the substrate may be, for example, in the form a plate, a sheet, a film, a rod, a sphere, fibers, a powder, a lens, or any other regular or irregular shape.

### (Curing Method)

In the present disclosure, the curing method and curing conditions of the curable composition are selected depending on whether the composition is active energy ray-curable and/or thermosetting. The curing conditions (for example, the type of light source, light irradiation dose and the like in a case in which the curable composition is active energy ray-curable, and heating temperature, heating time and the like in a case in which the curable composition is thermosetting) can be selected, as appropriate, depending on the type and the amount of the polymerization initiator, the type of the other polymerizable compound and the like, contained in the present composition.

### (1) Method of Curing by Active Energy Ray

In a case in which the present composition is an active energy ray-curable composition, the composition can be cured by a curing method in which an active energy ray is irradiated using a known active energy ray irradiation apparatus or the like. The active energy ray may be, for example, an electron beam, ultraviolet light, visible light, or light such as X-ray. The active energy ray is preferably light, and more preferably ultraviolet light, from the viewpoint that an inexpensive apparatus can be used.

The irradiation of ultraviolet light can be performed, for example, by an apparatus such as a low-pressure mercury lamp, a medium-pressure mercury lamp, a high-pressure mercury lamp, an ultra-high-pressure mercury lamp, a metal halide lamp, an ultraviolet (UV) electrodeless lamp, a chemical lamp, a black light lamp, a microwave-excited mercury lamp, or a light-emitting diode (LED).

The light irradiation to a coating film formed by coating the present composition can be performed at a light irradiation intensity selected depending on the purpose, application and the like. The light irradiation intensity in an optical wavelength range (varies depending on the type of photopolymerization initiator, but light having a wavelength of from 220 nm to 460 nm is preferably used) effective for activating an active energy ray polymerization initiator (referred to as “photopolymerization initiator” in a case in which the initiator is photocurable) is preferably from 0.1 mW/cm² to 1,000 mW/cm².

Further, the irradiation energy of the active energy ray should be set as appropriate, depending on the type of the active energy ray, mixing composition and the like. Likewise, the light irradiation to the coating film can be performed for a light irradiation time selected depending on the purpose, application and the like. The light irradiation time is preferably set such that the cumulative amount of light, which is represented as the product of the light irradiation intensity and the light irradiation time in the optical wavelength range described above, is within the range of from 10 mJ/cm² to 7,000 mJ/cm². The cumulative amount of light is more preferably from 200 mJ/cm² to 5,000 mJ/cm², and still more preferably from 500 mJ/cm² to 4,000 mJ/cm². When the cumulative amount of light is within the range described above, the curing of the composition proceeds smoothly, and a homogeneous cured product can be obtained easily.

If appropriate, heat curing can be performed in combination, before and/or after the photocuring.

For example, it is also possible to perform a two-stage curing, in which: the present composition is impregnated into a substrate that has a portion to be in shade in a case in which light is irradiated thereto, for example; then light is irradiated to the substrate to cure the present composition at a portion where the light hits, first; and thereafter, heat is applied to the substrate to cure the present composition at the portion where the light does not hit. Such a substrate is not particularly limited, and may be, for example, a substrate in the form of a fabric, fibers, a powder, a porous shape, or a complex shape such as an uneven shape. The substrate may also have a shape in which two or more of the above-described shapes are combined.

### (2) Heat Curing Method

In a case in which the present composition is a thermosetting composition, the curing method and curing conditions thereof are not particularly limited.

The curing is performed preferably at a curing temperature of from 80° C. to 200° C., more preferably from 100° C. to 180° C., and still more preferably from 110° C. to 150° C. The curing temperature may be maintained constant, or increased. Further, an increase and a decrease in the temperature may be combined.

The curing is performed for a curing time which can be selected as appropriate depending on the type of the thermal polymerization initiator, the content ratio of other components and the like. The curing time is preferably from 10 minutes to 360 minutes, more preferably from 30 minutes to 300 minutes, and still more preferably from 60 minutes to 240 minutes. When the composition is cured under the preferred conditions described above, it is possible to form a homogeneous cured film without swelling, cracks and the like.

### (Application of Silsesquioxane Derivative and the Like)

The cured product according to the present disclosure has an excellent hardness, and thus can be used in a hard coat, an optical member or the like. Further, a hard coat having an excellent hardness can be obtained by curing a hard coat agent containing the curable composition according to the present disclosure. A hard coat agent according to the present disclosure may be provided on a substrate. For example, a substrate including a hard coat can be obtained by curing the hard coat agent coated on the substrate. The hard coat agent according to the present disclosure may contain any of various components, if necessary.

The cured product or the hard coat according to the present disclosure has an excellent weatherability. The reason for this is assumed to be as follows: the fact that the silsesquioxane derivative according to the present disclosure has a low curing shrinkage ratio causes a decrease in residual stress at an interface between the cured product or the hard coat according to the present disclosure and the substrate, to improve adhesion, making the cured product or the hard coat less susceptible to a decrease in adhesion even under harsh conditions.

The silsesquioxane derivative according to the present disclosure has a low viscosity, and is capable of producing a cured product having an excellent hardness. The fact that the silsesquioxane derivative has a low viscosity leads to excellent coating properties in the absence of a solvent, and, even in the case of using a solvent, enables to reduce the amount of the solvent used.

Since the silsesquioxane derivative according to the present disclosure has a low viscosity, the derivative can be suitably used in an application that requires a low viscosity. For example, the silsesquioxane derivative can be used in an adhesive application, a printing application such as ink-jet or 3D printing, a coating agent application, a nanoprinting application or the like. Further, since the silsesquioxane derivative according to the present disclosure has a low viscosity, an excellent fine transferability can be achieved in a case in which it is used in a nanoprinting application. In addition, since the silsesquioxane derivative according to the present disclosure can be used in the absence of a solvent, the present composition can be poured into a mold, and then cured as it is.

The silsesquioxane derivative according to the present disclosure may be used in combination with a filler, the other polymerizable compound or the like. Since the silsesquioxane derivative according to the present disclosure has a low viscosity, it is also possible to mix with a large amount of filler.

The cured product according to the present disclosure or the hard coat according to the present disclosure preferably has an elastic modulus at 23° C. of more than 4.0 GPa, more preferably more than 4.1 GP, still more preferably more than 4.1 GPa but equal to or less 9.0 GPa, particularly preferably from 4.15 GPa to 8.0 GPa, and most preferably from 4.20 GPa to 7.0 GPa.

### EXAMPLES

The present disclosure will now be described specifically, based on Examples and Comparative Examples. However, the present disclosure is in no way limited to the following Examples.

### (Measurement of Weight Average Molecular Weight)

The weight average molecular weight (Mw) of the silsesquioxane derivative in each of Examples and Comparative Examples was measured as follows. Specifically, the silsesquioxane derivative was separated by a gel permeation chromatograph (HLC-8320 GPC, manufactured by Tosoh Corporation; hereinafter referred to as “GPC”) using a GPC column “TSK-GEL SuperMultipore HZ-M” (manufactured by Tosoh Corporation), in a tetrahydrofuran solvent at 40° C., and the molecular weight in terms of standard polystyrene was calculated from the retention time.

### (Measurement of Viscosity)

The viscosity at 25° C. of the silsesquioxane derivative in each of Examples and Comparative Examples was measured, using a Model TVE22H viscometer, manufactured by Toki Sangyo Co., Ltd.

### (Measurement of Density)

The density of the silsesquioxane derivative in each of Examples and Comparative Examples was measured, in accordance with JIS K0061-7.

### (Calculation of Molar Ratio of Each Structural Unit of Silsesquioxane Derivative)

The molar ratio of each structural unit in the silsesquioxane derivative in each of Examples and Comparative Examples was calculated by performing ¹H-NMR analysis, and further performing ²⁹Si-NMR analysis, if necessary, on a sample dissolved in deuterated chloroform.

### Example 1

### (Synthesis of Silsesquioxane Derivative)

Into a 1 L four-neck round bottom flask to which a thermometer, a dropping funnel and a stirring blade were attached, (3-acryloyloxy)propyltrimethoxysilane (140.6 g, 0.6 mol), 3-methacryloxypropyltrimethoxysilane (99.3 g, 0.4 mol), 2-propanol (64.6 g) and hydroquinone (0.085 g) were weighed, and the resulting mixed liquid was thoroughly stirred in a water bath at about 30° C. Separately, 35% hydrochloric acid (1.0 g, 9.6 mmol in terms of hydrogen chloride) and pure water (150.7 g) were mixed to prepare an aqueous solution. The prepared aqueous solution was added dropwise to the mixed liquid through the dropping funnel over about one hour, the resulting reaction liquid was stirred while performing the dropwise addition, and the reaction liquid was left to stand at room temperature overnight. The amount of water to be added was set to 2.8 molar times the total amount of hydrolyzable groups in organic silicon compounds as raw materials. Thereafter, the solvent and the like in the reaction liquid was removed by distillation under reduced pressure, while heating the reaction liquid to 60° C., to obtain 170 g of a silsesquioxane derivative 1 (S1) which is a colorless transparent liquid. The ¹H-NMR analysis on S1 confirmed the fact that the respective structural units had been introduced quantitatively according to the ratios of the raw materials introduced. The synthesized silsesquioxane derivative 1 had a viscosity at 25° C. of 6,270 mPa·s, and a weight average molecular weight (Mw) of 2,010.

### Examples 2 to 9

Silsesquioxane derivatives 2 to 9 (S2 to S9) were obtained in the same manner as in Example 1, except that the amounts of the raw materials introduced were changed as shown in Table 1, from those in Example 1, and that the amounts of solvent and the like were changed as appropriate. In each of Examples 5 to 7 and 9, 1,3-divinyltetramethyldisiloxane was used as the raw material from which the M unit of the silsesquioxane derivative is derived.

The amount of water added at the time of synthesis, the molar ratio of each structural unit in the silsesquioxane derivative, the viscosity at 25° C. and the weight average molecular weight (Mw), of each of the synthesized silsesquioxane derivatives 2 to 9, are shown in Table 1.

### Examples 10 to 12

Silsesquioxane derivatives 10 to 12 (S10 to S12) were obtained in the same manner as in Example 1, except that the amounts of the raw materials introduced were changed as shown in Table 1, from those in Example 1, and that the amounts of solvent and the like were changed as appropriate. In each of Examples 10 to 12, dimethyldimethoxysilane was used as the raw material from which the D unit of the silsesquioxane derivative is derived.

The amount of water added at the time of synthesis, the molar ratio of each structural unit in the silsesquioxane derivative, the viscosity at 25° C. and the weight average molecular weight (Mw), of each of the synthesized silsesquioxane derivatives 10 to 12, are shown in Table 1.

### Comparative Examples 1, 3 and 4

Silsesquioxane derivatives C1, C3 and C4 (SC1. SC3 and SC4) were obtained in the same manner as in Example 1, except that the amounts of the raw materials introduced were changed as shown in Table 1, from those in Example 1, and that the amounts of solvent and the like were changed as appropriate.

The amount of water added at the time of synthesis, the molar ratio of each structural unit in the silsesquioxane derivative, the viscosity at 25° C. and the weight average molecular weight (Mw), of each of the synthesized silsesquioxane derivatives C1, C3 and C4 are shown in Table 1.

### Comparative Example 2

A silsesquioxane derivative C2 (SC2) was synthesized in accordance with the method of Example 1 described in JP-A No. H10-030068, and without using an organic solvent as a reaction solvent. The amount of water added at the time of synthesis, the molar ratio of each structural unit in the silsesquioxane derivative, the viscosity at 25° C. and the weight average molecular weight (Mw), of the synthesized silsesquioxane derivative 9, are shown in Table 1.

### (Evaluation of Storage Stability)

A quantity of 1 g of the silsesquioxane derivative obtained in each of the Examples and Comparative Examples was weighed into a 9 mL screw cap vial, and the viral was left to stand for seven days in a thermostatic chamber controlled to 60° C. Thereafter, the viscosity at 25° C. of each silsesquioxane derivative was measured in the same manner as described above (namely, the viscosity of each silsesquioxane derivative subjected to an accelerated test was measured). The storage stability was evaluated in accordance with the following criteria, based on the rate of increase in viscosity before and after the accelerated test ((viscosity after the test)/(viscosity before the test)). The results are shown in Table 1.

### —Evaluation Criteria—

A: Less than 1.3
B: 1.3 or more, or the occurrence of gel component is observed.

### (Preparation of Photocurable Composition)

To one part by mass of each synthesized silsesquioxane derivative, 0.03 parts by mass of 2-hydroxy-2-methyl-1-phenylpropan-1-one was added, and the resulting mixture was stirred with a rotation and revolution mixer, to obtain each photocurable composition. Since the solvent and the like had been removed by distillation, at the time of the synthesis of each silsesquioxane derivative, each photocurable composition does not substantially contain any solvent.

### (Preparation of Photocured Product)

Each photocurable composition prepared as described above was poured into a silicone mold placed on a polyethylene terephthalate (PET) release film, another PET release film was layered on the mold, and the resultant was sandwiched with glass plates and fixed. Thereafter, each photocurable composition was cured by being irradiated with ultraviolet light under the following conditions, to obtain each photocured product.

### —Ultraviolet Light Irradiation Conditions—

Lamp: a high-pressure mercury lamp (ECS-4011 GX, manufactured by EYE GRAPHICS Co., Ltd.)
Lamp height: 10 cm
Conveyor speed: 5.75 m/min
Cumulative amount of light per pass: 360 mJ/cm² (UV-A, a value measured by a UV POWER PUCK II, manufactured by Endicott Interconnect Technologies. Inc.)
Atmosphere: in the atmosphere
Number of passes: 20

### (Measurement of Density of Photocured Product)

The density of each photocured product prepared as described above was measured in accordance with JIS K0061-8.

### (Evaluation of UV Curability)

A LIGHTNINGCURE LC5, manufactured by Hamamatsu Photonics K.K., was connected to an MCR-301 manufactured by Anton Paar Inc. Ultraviolet light (UV) was irradiated to each photocurable composition prepared as described above while applying a shear strain thereto, to record the behavior of an increase in storage elastic modulus during UV irradiation, and the UV curing rate (UV curability) of each photocurable composition was evaluated. The storage elastic modulus of each photocurable composition was measured by applying a 0.05% strain at 1 Hz, at a temperature of 25° C. in a nitrogen gas stream, using a pair of parallel plates having a diameter of 8 mm. A high-pressure mercury lamp was used as a UV light source, and a short wavelength of 365 nm alone was irradiated to each photocurable composition, by passing through a heat ray cut filter, a band pass filter and a natural density filter. The irradiation intensity of UV at this time was 10 mW/cm². The UV curability was evaluated in accordance with the following criteria, based on the value of the storage elastic modulus of each photocurable composition in a case in which UV was irradiated for 10 seconds. A better UV curability is indicated in the order of A>B>C.

The experimental results are shown in Table 1.

### —Evaluation Criteria—

A: 5.0×10⁶ Pa or more
B: 1.0×10⁶ Pa or more but less than 5.0×10⁶ Pa
C: Less than 1.0×10⁶ Pa

### (Preparation of Photocurable Coating Agent)

To one part by mass of each synthesized silsesquioxane derivative, 0.03 parts by mass of 2-hydroxy-2-methyl-1-phenylpropan-1-one and one part by mass of propylene glycol monobutyl ether were added, and the resulting mixture was stirred with a rotation and revolution mixer, to obtain each photocurable coating agent.

### (Preparation of Photocured Film)

Each photocurable coating agent prepared as described above was coated on a TAC (triacetyl cellulose) film having a thickness of 80 μm. Specifically, each photocurable coating agent was coated using a No. 20 bar coater. Thereafter, each coated photocurable coating agent was dried at 60° C. for 10 minutes, and then irradiated with ultraviolet light under the following conditions, to prepare each photocured film. Each photocured film had a film thickness of about 10 μm.

### —Ultraviolet Light Irradiation Conditions—

Lamp: a high-pressure mercury lamp (ECS-4011 GX, manufactured by EYE GRAPHICS Co., Ltd.)
Lamp height: 10 cm
Conveyor speed: 5.75 m/min
Cumulative amount of light per pass: 360 mi/cm² (UV-A, a value measured by a UV POWER PUCK II, manufactured by Endicott Interconnect Technologies, Inc.)
Atmosphere: in the atmosphere
Number of passes: 10

### (Pencil Hardness Test)

Each photocured film prepared as described above was subjected to a pencil hardness test, in accordance with JIS K5600-5-4 (1999) (ISO/DIS 15184: 1996). The experimental results are shown in Table 1.

### (Measurement of Elastic Modulus)

The elastic modulus of each photocured film prepared as described above was measured as follows. Specifically, the indentation hardness of each photocured film was measured at 23° C. and a strain rate of 0.05/s, by a nanoindenter (Nano Indenter G200 manufactured by Agilent Technologies, using a Berkovich indenter). The measured Modulus values at an indentation depth of from 500 nm to 800 nm were averaged to calculate the elastic modulus. The experimental results are shown in Table 1.

### (Calculation of Curing Shrinkage Ratio)

The curing shrinkage ratio was calculated based on: (density of cured product−density before curing)/density before curing 100. The results are shown in Table 1.

### (Weathering Test)

The photocured films of Examples 1 to 12 and Comparative Examples 1 to 4 were prepared in the same manner as in the section of (Preparation of Photocured Film) described above, except that a 1 mm-thick polycarbonate (PC) plate (YUPILON, manufactured by Engineering Test Service Co., Ltd.) was used as the substrate, for each film. Ultraviolet light was irradiated to each of the thus prepared films under the following conditions, using a METAL WEATHER tester, manufactured by Daipla Wintes CO., LTD.
Light source: a metal halide lamp
Illuminance: 138 mW/cm²
Irradiation time: 90 hours continuously, with water showering for 2 minutes everv two hours.
Temperature: 63° C.
Humidity: 70%

A cross-cut method in accordance with JIS K5600-5-6 (1999) (ISO 2409: 1992) was performed before and after the irradiation of ultraviolet light, to evaluate the adhesion of each photocured film before and after a cross-cut peeling weathering test. Those in which the number of the remaining cross-cut squares, among 25 cross-cut squares, is 15 or more were evaluated as A, those in which the number of the remaining cross-cut squares is more than 0 but less than 15 were evaluated as B. and those in which all the cross-cut squares had peeled off were evaluated as C.

### Overall Evaluation

Overall evaluation for each of Examples 1 to 12 and Comparative Examples 1 to 4 were carried out in accordance with the following criteria, based on the evaluation results of seven evaluation items, namely, the storage stability, the UV curability, the elastic modulus, the curing shrinkage ratio, the pencil hardness, the adhesion before the cross-cut peeling weathering test, and the adhesion after the cross-cut peeling weathering test. The results of overall evaluation are shown in Table 1. The criteria for being “excellent” in the evaluation results of the seven evaluation items are as shown below, and the overall evaluation was carried out based on the criteria.

### —Criteria for Being Excellent—

{Storage stability} The storage stability is evaluated as A.
{UV curability} The UV curability is evaluated as A.
{Elastic modulus} The elastic modulus is more than 4.0 GPa.
{Curing shrinkage Ratio} The curing shrinkage ratio is 7.3% or less.
{Pencil hardness} The pencil hardness is equal to or higher than 5H.
{Adhesion before the cross-cut peeling weathering test} The adhesion before the cross-cut peeling weathering test is evaluated as A.
{Adhesion after the cross-cut peeling weathering test} The adhesion after the cross-cut peeling weathering test is evaluated as A.

### —Evaluation Criteria for Overall Evaluation—

S: All of the evaluation results of the seven evaluation items are excellent.
A: Among the evaluation results of the seven evaluation items, six items were evaluated as excellent.
B: Among the evaluation results of the seven evaluation items, five items were evaluated as excellent.
C: Among the evaluation results of the seven evaluation items, four or less items were evaluated as excellent.

TABLE 1

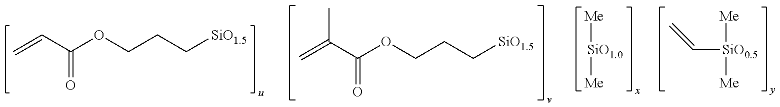

| | | | | | | | | | | | | | | Adhe- | Adhe- | |
|---|---|---|---|---|---|---|---|---|---|---|---|---|---|---|---|---|
| | | | | | A- | | | | | | | | | sion | sion | |
| | | | | | mount | | | | | | | | | before | after | |
| | | | | | of | | | | | | | | | cross- | cross- | O- |
| | | | | | water | | | | | | Elas- | | | cut | cut | ver- |
| | | | | | added | | | | stor- | UV | tic | Curing | | peeling | peeling | all |
| | | | | | (molar | | | Vis- | age | cur- | mo- | shrink- | Pen- | wea- | wea- | e- |
| | | | | | e- | | | cosity | sta- | a- | du- | age | cil | ther- | ther- | val- |
| | | | | | quiva- | | Mw/ | (mPa · | bili- | bili- | lus | ratio | hard- | ing | ing | ua- |
| | u | v | x | y | lent) | Mw | Mn | s) | ty | ty | (GPa) | (%) | ness | test | test | tion |
| Com- | 0.6 | 0.4 | 0 | 0 | 1.0 | 1.470 | 1.184 | 4.390 | A | A | 3.9 | 7.6 | ≤4H | A | C | C |
| para- | | | | | | | | | | | | | | | | |
| tive | | | | | | | | | | | | | | | | |
| Ex- | | | | | | | | | | | | | | | | |
| ample | | | | | | | | | | | | | | | | |
| 4 | | | | | | | | | | | | | | | | |
| Ex- | 0.6 | 0.4 | 0 | 0 | 2.8 | 2.010 | 1.293 | 6.270 | A | A | 4.3 | 6.3 | ≥5H | A | A | S |
| am- | | | | | | | | | | | | | | | | |
| ple 1 | | | | | | | | | | | | | | | | |
| Ex- | 0.6 | 0.4 | 0 | 0 | 3.0 | 2.330 | 1.325 | 7.010 | A | A | 4.3 | 6.2 | ≥5H | A | A | S |
| am- | | | | | | | | | | | | | | | | |
| ple 2 | | | | | | | | | | | | | | | | |
| Ex- | 0.6 | 0.4 | 0 | 0 | 3.5 | 2.540 | 1.365 | 8.150 | A | A | 4.2 | 6.2 | ≥5H | A | A | S |
| am- | | | | | | | | | | | | | | | | |
| ple 3 | | | | | | | | | | | | | | | | |
| Ex- | 0.6 | 0.4 | 0 | 0 | 25 | 2.060 | 1.401 | 4.370 | B | A | 4.1 | 6.2 | ≥5H | A | A | A |
| am- | | | | | | | | | | | | | | | | |
| ple 8 | | | | | | | | | | | | | | | | |
| Ex- | 0.595 | 0.4 | 0 | 0.005 | 2.0 | 2.020 | 1.263 | 5.840 | A | A | 4.1 | 7.3 | ≤4H | A | B | B |
| am- | | | | | | | | | | | | | | | | |
| ple 9 | | | | | | | | | | | | | | | | |
| Ex- | 0.595 | 0.4 | 0 | 0.005 | 2.5 | 2.200 | 1.301 | 6.390 | A | A | 4.2 | 6.6 | ≥5H | A | A | S |
| am- | | | | | | | | | | | | | | | | |
| ple 5 | | | | | | | | | | | | | | | | |
| Ex- | 0.595 | 0.4 | 0 | 0.005 | 2.7 | 2.680 | 1.381 | 6.590 | A | A | 4.3 | 6.3 | ≥5H | A | A | S |
| am- | | | | | | | | | | | | | | | | |
| ple 6 | | | | | | | | | | | | | | | | |
| Ex- | 0.595 | 0.4 | 0 | 0.005 | 2.8 | 2.070 | 1.315 | 6.410 | A | A | 4.3 | 6.2 | ≥5H | A | A | S |
| am- | | | | | | | | | | | | | | | | |
| ple 7 | | | | | | | | | | | | | | | | |
| Ex- | 0.5 | 0.5 | 0 | 0 | 2.8 | 2.000 | 1.295 | 6.330 | A | B | 4.3 | 6.2 | ≥5H | A | A | A |
| am- | | | | | | | | | | | | | | | | |
| ple 4 | | | | | | | | | | | | | | | | |
| Com- | 1 | 0 | 0 | 0 | 1.0 | 2.330 | 1.377 | 5.990 | 4 | A | 3.6 | 8.9 | ≤4H | A | C | C |
| para- | | | | | | | | | | | | | | | | |
| tive | | | | | | | | | | | | | | | | |
| Ex- | | | | | | | | | | | | | | | | |
| am- | | | | | | | | | | | | | | | | |
| ple 1 | | | | | | | | | | | | | | | | |
| Com- | 1 | 0 | 0 | 0 | 25 | 2.490 | 1.442 | 4.780 | B | A | 2.8 | 6.4 | ≤4H | A | A | C |
| para- | | | | | | | | | | | | | | | | |
| tive | | | | | | | | | | | | | | | | |
| Ex- | | | | | | | | | | | | | | | | |
| am- | | | | | | | | | | | | | | | | |
| ple 2 | | | | | | | | | | | | | | | | |
| Com- | 0 | 1 | 0 | 0 | 1.0 | 1.310 | 1.132 | 4.050 | A | C | 4.0 | 7.4 | ≤4H | A | C | C |
| para- | | | | | | | | | | | | | | | | |
| tive | | | | | | | | | | | | | | | | |
| Ex- | | | | | | | | | | | | | | | | |
| am- | | | | | | | | | | | | | | | | |
| ple 3 | | | | | | | | | | | | | | | | |
| Ex- | 0.595 | 0.4 | 0.005 | 0 | 2.8 | 2.980 | 1.443 | 6.270 | A | A | 4.2 | 6.2 | ≥5H | A | A | S |
| am- | | | | | | | | | | | | | | | | |
| ple 10 | | | | | | | | | | | | | | | | |
| Ex- | 0.585 | 0.39 | 0.025 | 0 | 2.8 | 2.560 | 1.390 | 6.130 | A | A | 4.1 | 6.1 | ≤4H | A | A | A |
| am- | | | | | | | | | | | | | | | | |
| ple 11 | | | | | | | | | | | | | | | | |
| Ex- | 0.585 | 0.39 | 0.025 | 0 | 3.0 | 3.730 | 1.575 | 6.710 | A | A | 4.1 | 6.1 | ≤ 4H | A | A | A |
| am- | | | | | | | | | | | | | | | | |
| ple 12 | | | | | | | | | | | | | | | | |

As shown in Table 1, the silsesquioxane derivatives obtained in Example 1 to Example 12 had a lower curing shrinkage ratio and gave cured products having a better hardness, as compared to those obtained in Comparative Example 1 to Comparative Example 4.

The silsesquioxane derivatives obtained in Example 1 to Example 7 and Example 9 to Example 12 had an excellent storage stability, as well.

The silsesquioxane derivatives obtained in Example 1 to Example 3 and Example 5 to Example 12 had an excellent UV curability, as well.

The silsesquioxane derivatives obtained in Example 1 to Example 8 and Example 10 gave cured products having an excellent pencil hardness, as well.

Further, the silsesquioxane derivatives obtained in Example 1 to Example 12 gave cured products having an excellent weatherability.

In addition, the silsesquioxane derivatives obtained in Example 1 to Example 12 had a better overall evaluation for the storage stability, the UV curability, the elastic modulus, the curing shrinkage ratio, the pencil hardness, the adhesion before the cross-cut peeling weathering test and the adhesion after the cross-cut peeling weathering test, as compared to those obtained in Comparative Example 1 to Comparative Example 4.

The disclosure of Japanese Patent Application No. 2022-094443 filed on Jun. 10, 2022 is incorporated herein by reference in its entirety. All publications, patent applications, and technical standards described in the present specification are incorporated herein by reference to the same extent as if each individual publication, patent application, and technical standard are specifically and individually indicated to be incorporated by reference.

1. A silsesquioxane derivative represented by the following Formula (1), wherein a cured product obtained by curing the derivative has an elastic modulus at 23° C. of more than 4.0 GPa: 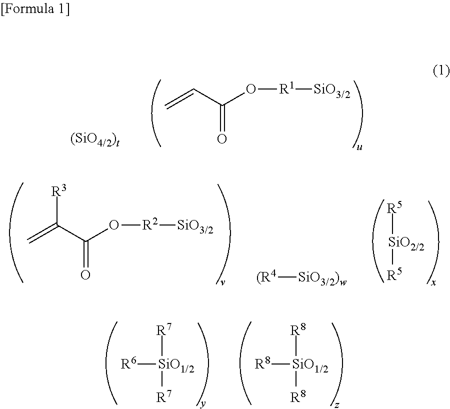
wherein, in Formula (1), each of R¹ and R² independently represents an alkylene group having from 1 to 10 carbon atoms, a cycloalkylene group having from 3 to 10 carbon atoms, an arylene group having from 6 to 10 carbon atoms, or an aralkylene group having from 7 to 12 carbon atoms; R³ represents an alkyl group having from 1 to 6 carbon atoms; each of R⁴ and respective R⁵s independently represents a hydrogen atom, a saturated or unsaturated alkyl group having from 1 to 20 carbon atoms, a saturated or unsaturated cycloalkyl group having from 3 to 8 carbon atoms, an aryl group having from 6 to 20 carbon atoms, or an aralkyl group having from 7 to 20 carbon atoms; R⁶ represents an organic group having from 2 to 12 carbon atoms and containing at least one of an ethylenically unsaturated bond or a carbon-carbon triple bond; each R⁷ and each R⁸ independently represents an alkyl group having from 1 to 10 carbon atoms, an aryl group having from 6 to 10 carbon atoms, or an aralkyl group having from 7 to 10 carbon atoms; a plurality of R⁵s may be the same as, or different from, each other; a plurality of R⁷s may be the same as, or different from, each other; a plurality of R⁸s may be the same as, or different from, one another; a part of a structure of each of R¹ to respective R⁸s may be independently substituted with a substituent or a halogen atom; each of t, u, v, w, x, y and z independently represents 0 or a positive number; and at least one of u or v is a positive number.

2. The silsesquioxane derivative according to claim 1, having a curing shrinkage ratio of 7.3% or less.

3. The silsesquioxane derivative according to claim 1, wherein t, x and z are 0, and y, u, v and w satisfy 0≤y/(u+v+w) s 0.5.

4. The silsesquioxane derivative according to claim 1, wherein t, y and z are 0, and x, u, v and w satisfy 0≤x/(u+v+w) s 0.5.

5. The silsesquioxane derivative according to claim 1, wherein each of u and v independently represents a positive number.

6. The silsesquioxane derivative according to claim 5, wherein v and u satisfy 0<v/u≤1.

7. A curable composition, comprising:
the silsesquioxane derivative according to claim 1; and
a polymerization initiator.

8. A hard coat agent, comprising the curable composition according to claim 7.

9. A cured product obtained by curing the curable composition according to claim 7.

10. A hard coat obtained by curing the hard coat agent according to claim 8.

11. A substrate, comprising the hard coat according to claim 10.

12. A method of producing the silsesquioxane derivative according to claim 1, the method comprising hydrolyzing at least one organic silicon compound represented by RₙSiXₚ using an organic solvent, and adding water in an amount of from 2 molar equivalents to 30 molar equivalents with respect to a total amount of hydrolyzable groups contained in the organic silicon compound, wherein n represents an integer from 0 to 3, p represents an integer from 1 to 4, a sum of n and p is 4, R represents a group that binds to a silicon atom through a carbon atom, in the silsesquioxane derivative, and X represents a hydrolyzable group.
